(19) United States
(12) Patent Application Publication
(10) Pub. No.: US 2024/0322457 A1
(43) Pub. Date: Sep. 26, 2024

(54) Lay-In Split Bolt Connector

(71) Applicant: ERICO International Corporation, Solon, OH (US)

(72) Inventors: Thomas Bendlak, Macedonia, OH (US); Dale Boling, Avon, OH (US); Marianna Palmer, Chesterland, OH (US); Tom M. Colangelo, Lombard, IL (US); Huy Nguyen, Cuyahoga Falls, OH (US); Brent Wilmoth, Cuyahoga Falls, OH (US)

(21) Appl. No.: 18/612,780

(22) Filed: Mar. 21, 2024

Related U.S. Application Data
(60) Provisional application No. 63/491,560, filed on Mar. 22, 2023.

(51) Int. Cl. H01R 4/32; H01R 4/38

(52) U.S. Cl. CPC H01R 4/32; H01R 4/38

(57) ABSTRACT

A split bolt connector can include a main body with a slot that extends between first and second ends of the main body in an axial direction, a nut configured to be threadedly movable along the slot, and an insert within the slot. The main body can define a lay-in opening along the slot to receive a conductor laterally through the main body into the slot.

### CROSS-REFERENCE TO RELATED APPLICATIONS

This application claims priority to and incorporates by reference U.S. provisional patent application No. 63/491,560, filed Mar. 22, 2023.

### BACKGROUND

In many applications, it may be useful to connect two or more conductors, such as copper or other wire. For example, conductors can be secured together to provide electrical continuity for grounding or other applications.

### SUMMARY

Some embodiments of the invention provide a split bolt connector configured to connect a first and a second conductor. The split bolt connector can include a main body having shaft that includes external threads and defines an axial direction. The main body can further include a slot that extends between first and second ends of the main body in the axial direction. The split bolt connector may further include a nut engaged with the external threads to be threadedly movable along the slot. The split bolt connector may further include an insert within the slot, the insert being movable along the slot by rotation of the nut. The split bolt connector may further include the main body defining a lay-in opening along the slot to receive a conductor laterally through the main body into the slot.

Some embodiments of the invention provide a method of connecting a first and a second conductor. A split bolt connector can be provided. A first conductor can be installed into a slot of the split bolt connector through a lay-in opening, and a second conductor can be installed into a slot of the split bolt connector (e.g., also through the lay-in opening) to electrically connect the second conductor to the first conductor.

Some embodiments of the invention provide a method of connecting a conductor and a cable tray. A main body of a split bolt connecter can be aligned with a cable tray so that a lay-in opening can be aligned with a wire of the cable tray. A nut can be engaged with the external threads of the shaft to secure an insert within a first slot that extends in an axial direction between first and second ends of the main body. The main body can be moved to insert the wire of the cable tray laterally into the first slot via the lay-in opening. The nut can be tightened to move the insert axially along the first slot to secure the wire within the first slot and securing a conductor to the main body to electrically connect the conductor to the wire of the cable tray.

Some embodiments of the invention provide a split bolt connector assembly. A split bolt connector can include a main body having a shaft that includes external threads and defines an axial direction, and a first slot that extends between first and second ends of the main body in the axial direction. The main body can further have a nut engaged with the external threads to be threadedly movable along the external threads, and an insert within the first slot. The insert can be movable in the axial direction along the first slot by rotation of the nut. The main body can define a lay-in opening along the first slot that opens laterally through the main body into the first slot. The main body can include a second slot that is separated from the first slot by material of the main body and opens out of the main body at the first end of the main body. The split bolt connector can have an installed configuration in which the insert is seated on the nut with the nut at least partly between the lay-in opening with the first end of the main body and the legs extending axially through the nut and beyond the lay-in opening.

Some embodiments of the invention provide a method of prefabricating a connector assembly. A nut can be secured to the external threads of a shaft of a main body of a split bolt connector. The nut can secure an insert within a first slot that extends in an axial direction along the shaft between first and second ends of the main body. A lay-in opening can be provided into the first slot to receive a wire of a cable tray into. the first slot. The wire can be secured in the first slot by the insert to electrically bond the main body to the wire. A conductor can be secured within a second slot of the main body that is separated from the first slot by material of the main body so that the conductor is electrically bonded to the main body.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a split bolt connector with a round head.

FIG. 2 is an isometric view of a split bolt connector with a hexagonal head.

FIG. 3 is an isometric view of a split bolt connector with a service post head.

FIG. 4 is an isometric view of the split bolt connector of FIG. 1, with a detail illustration of a surface feature of the split bolt connector.

FIG. 5 is a front elevation view of the split bolt connector of FIG. 1, with a first and a second conductor installed.

FIG. 6 is an isometric view of a split bolt connector with a hexagonal head and an insert with extended legs, with a detailed inset showing the insert.

FIG. 7 is an isometric exploded view of the split bolt connector of FIG. 6.

FIG. 8 is an isometric view of a split bolt of the split bolt connector of FIG. 6.

FIG. 9 is an isometric view of a split bolt connector with a round head and an insert with extended legs.

FIG. 10 is an isometric exploded view of the split bolt connector of FIG. 9.

FIG. 11 is an isometric view of a split bolt of the split bolt connector of FIG. 9.

FIGS. 12A through 12C are front elevation views of the split bolt connector of FIG. 9 in different assembled configurations.

FIG. 13 is an isometric view of a split bolt connector with a set screw.

FIG. 14 is a cross-sectional side elevation view of the split bolt connector of FIG. 13.

FIGS. 15 through 17 illustrate an example method of installing the split bolt connector of FIG. 13 to two conductors.

FIG. 18 illustrates an example assembly with the split bolts of FIG. 9 and FIG. 13 attached to a wire tray and bonding wires.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to connect conductors together. In some examples, a split bolt connector can connect two or more pieces of copper wires or other conductors together to allow electricity to flow from one conductor to another and complete an electrical circuit. For example, split bolt connectors can be used for grounding or otherwise transferring power in cable and telephone lines, railway signal lines, building wiring systems, and direct burial applications.

Conventional designs can require a user to completely remove the nut of the connector to install the connector on an existing run of wire or other conductor installation (e.g., a wire of a cable tray). When connecting conductors using these split bolt connectors, there is accordingly a risk of the nut (or other hardware) becoming loose or lost, which can cost the installer additional time to connect the conductors.

Further, conventional designs may be used in relatively limited contexts and may not be equipped for particularly adaptable connection of two conductive components. For example, with conventional designs, installers may have to manage alignment, insertion, and securement of multiple components collectively relative to a single split bolt or split-bolt slot (e.g., while also managing loose hardware, as noted above).

Embodiments of the present invention can address these or other issues by providing split bolt connectors configured for lay-in connections or other applications. For example, some examples can include a main body defining a lay-in opening along a slot that extends between first and second ends of the main body in an axial direction. In some examples, this arrangement can provide flexibility of installation without loss of installation time or an extra step of removing the nut. In some examples, the main body includes outer threads, a slot configured to secure relevant conductors (e.g., wire basket and chain link fence), and a lay-in opening to receive the conductor(s) into the slot. With such an arrangement, for example, an installer can connect to a wire or other conductor without removal of any parts from the split bolt assembly (e.g., without removing a nut), including to easily mount the connector on an existing run of wire or the wire of an installed cable tray. In other words, inclusion of the lay-in opening can allow a user to connect conductors with a split bolt connector while keeping all the components of the split bolt connector together.

In some embodiments, a split bolt connector can include a rough surface (e.g., knurled or otherwise patterned) to allow an installer to remove any coating or other surface treatment or feature from the conduit. For example, a surface within or adjacent to a slot of a split bolt can include machined or other roughening surface treatment (e.g., knurling). Thus, in some examples, rough surfaces can be provided in a split bolt connector to remove coating (e.g., powder-paint coating) from a wire tray or chain link fence during the installation process. As similarly discussed above, such an arrangement may improve installation procedures by helping installers avoid the need for an extra step with other tools to ensure electrical continuity (e.g., for bonding or grounding).

In some embodiments, a split bolt connector can include a rounded head. This arrangement, for example, can be particularly beneficial for use with cable trays, as the rounded head can to provide a smooth surface for cables to pass by. For example, with a rounded head configuration for a split bolt connector, the smooth head surface can help to prevent damaging of the insulation of the conductors during installation of the connector or the conductors. However, in some embodiments, other geometries are possible. For example, a split bolt connector can include a standard hex head (or other profile) for some applications. Such an arrangement, for example, can allow for easier tightening of the corresponding nut during the installation process.

In some embodiments, a split bolt connector can include a service post that extends from a head of the main body to provide a connection to other equipment or structures. For example, a service post head can include a protruding threaded post that can allow a split bolt connector to be easily attached to building structure (e.g., a structural plate, to make a grounding connection).

In some embodiments, a split bolt connector can include a set screw or other mechanism (e.g., a tapered or other pin, a crimped structure, etc.) to secure a conductor separately from a main nut or slot of the connector. For example, a split bolt connector may include a first slot in a main body of a split bolt and a second slot in the head of the split bolt. Thus, for example, the first slot of the bolt can receive a wire of a wire tray or another conductor, to be held in place within the first slot by an insert and a nut. Further, the second slot of the bolt can receive a different conductor (e.g., for electrical bonding of wire trays or other dispersed components), to be held in place by a set screw or other mechanism. For example, the second slot may include a threaded portion to receive a set screw (or other geometry to receive a pin, etc.) and may also include a radiused (or other) blind end to securely seat a bonding wire or other conductor. A received conductor (e.g., a bonding wire for cable tray) can be accordingly secured in the second slot, including as part of a pre-fabricated assembly that can be collectively installed onto a cable tray or other existing installation.

In some embodiments, an insert may have legs of extended length, to help improve manufacturability and retention of the insert within the collective assembly. For example, some inserts may include legs that extend past the lay-in opening of a slot or farther (e.g.,. past the opposite end of the main body of the split bolt) when the insert is in an engaged position to secure wire within the slot. With such arrangements, for example, it may not be necessary to crimp or otherwise deform the insert around a corresponding nut for retention of the insert within the assembly.

Various particular geometric configurations of split bolt main bodies, heads, and other components are presented in the examples below. Unless otherwise specified, features of any particular example (e.g., head shapes, slot configurations, insert configurations, etc.) are also applicable for other examples (e.g., via simple substitution of structures between examples).

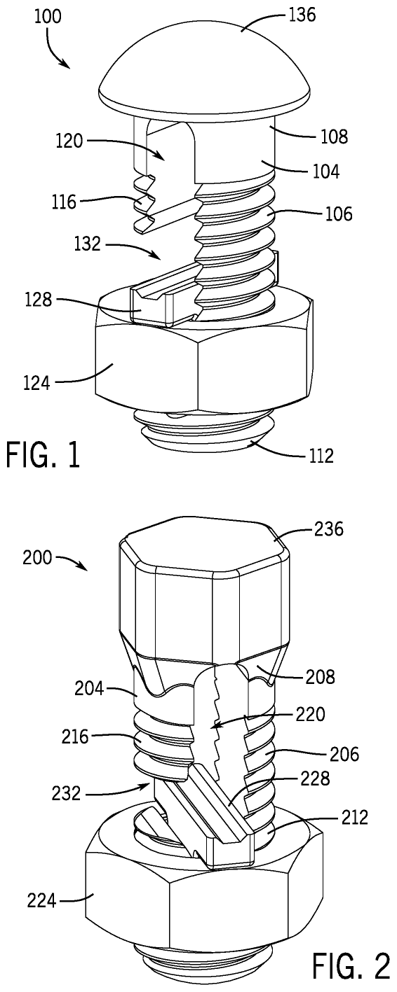

FIG. 1 illustrates an example split bolt connector 100 according to an embodiment of the invention. In the illustrated example, the connector 100 includes a main body 104 having a shaft 106 that includes external threads 116 and defines an axial direction. The split bolt connector 100 includes a slot 120 that extends between first 108 and second ends 112 of the main body 104 in the axial direction. A nut 124 is engaged with the external threads 116 to be threadedly movable along the slot 120, and an insert 128 is received within the slot 120 (and retained therein by the nut 124). As shown, the insert 128 is thus configured to be movable along the slot 120 by rotation of the nut 124 and can provide a large, smooth clamping area for conductors received within the slot 120 (not shown in FIG. 1). As the nut 124 is tightened on the split bolt connector 100, the conductors can thus be clamped together between the main body 104 and the insert 128.

To provide improved case of installation, the main body 104 also defines a lay-in opening 132 along the slot 120 to receive a conductor laterally through the main body 104 into the slot 120. In contrast to conventional designs, the split bolt connector 100 with the lay-in opening 132 thus allows a user to connect conductors through the main body 104 and into the slot 120 of the split bolt connector 100 without removing the nut 124 from the split bolt connector 100.

In some cases, as generally noted above, a rounded head can be provided. In the illustrated example of FIG. 1, the main body 104 includes a head 136 at the first axial end 108 that defines a rounded axial profile (and a larger diameter than the body 104 measured perpendicular to the axial direction). In particular, the head 136 is a circular round head with a circular perimeter relative to cross-sectional reference planes perpendicular to the axial direction, and with a spherical (or other) rounded profile protruding in the axial direction (e.g., relative to cross-sectional reference planes that are parallel to the axial direction). Thus, the circular perimeter can define the larger diameter of the head 136 relative to the main body 104, and the rounded profile of the head can provide a relatively smooth exposed surface once the split bolt connector 100 is installed. Thus, for example, the split bolt connector 100 with the round head 136 can be used for cable trays (not shown) to provide a smooth surface for cables of the tray to pass by, and thereby reduce the risk of damaging the cables. In some cases, a square neck (not shown) can be provided to engage relevant support structure and thereby allow the nut 124 to be easily tightened.

FIG. 2 illustrates another example split bolt connector 200 that includes a main body 204 having a shaft 206 that includes external threads 216 and defines an axial direction. Similarly, to the split bolt connector 100, the split bolt connector 200 includes a slot 220 that extends between first 208 and second ends 212 of the main body 204 in the axial direction and a nut 224 engaged with the external threads 216 to be threadedly movable along the slot 120. The split bolt connector 200 further includes an insert 228 that is captured within the slot 220 and is configured to be movable along the slot 220 by rotation of the nut 224. Further, the main body 204 defines a lay-in opening 232 along the slot 220, between the first and second ends 208, 212, to receive a conductor laterally through the main body 204 and into the slot 220.

In this illustrated example, the main body 204 includes a head 236 at the first end 208 that defines a flattened axial profile, with a larger diameter than the body 204 measured perpendicular to the axial direction. In contrast to the split bolt connector 100 with a round head 136, the head 236 is a polygonal head with a hexagonal (as shown) perimeter that defines the larger diameter of the head 236. The split bolt connector 200 with the hexagonal head 236 can be used for conductor-to-conductor applications where a rounded head surface may not be required. The geometry of the hexagonal head 236 allows for easier tightening of the nut 224 when using the split bolt connector 200.

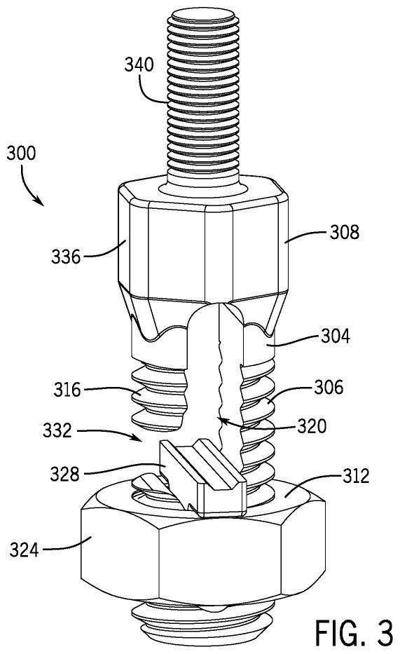

FIG. 3 illustrates another example split bolt connector 300 that includes a main body 304 having a shaft 306 that includes external threads 316 and defines an axial direction between the first 308 and second ends 312 of the main body 304. Similarly to the split bolt connectors 100, 200, the split bolt connector 300 includes a slot 320 that extends between first 308 and second ends 312 of the main body 204 in the axial direction and a nut 324 engaged with the external threads 316 to be threadedly movable along the slot 320. The split bolt connector 300 further includes an insert 328 within the slot 320. As shown, the insert 328 is configured to be movable along the slot 320 by rotation of the nut 324. The main body 304 defines a lay-in opening 332 along the slot 320 to receive a conductor laterally through the main body 304 and into the slot 320.

As generally noted above, a service post can be provided on a split bolt in some cases. In this illustrated example, the main body 304 includes a polygonal head 336 at the first end 308 and a threaded post 340 extending from the head 336 in the axial direction, opposite the slot 320. The threaded post 340 of the split bolt connector 300 can attach to various structures (e.g., steel plates) via a threaded hole or an additional nut (not shown). Thus, the threaded post 340 can help to make a grounding (or other) connection to the structure or to otherwise generally support the split bolt connector 300, and any included conductors, in an installed orientation.

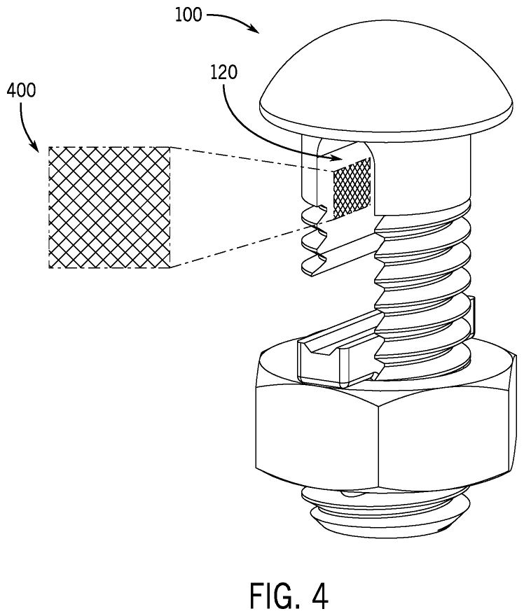

Also as generally noted above, some split bolt connectors according to the disclosure can include surfaces that have been roughened to help remove powder coating or other superficial layers on a conductor and thereby expose the metal of the conductor for electrical connection to the split bolt. For example, FIG. 4 illustrates the split bolt connector 100 with the main body formed to include one or more surface roughness features arranged to score a conductor (not shown) received into the slot. Such features, for example, can be included within the slot 120 (as shown) or can be included adjacent to the slot 120 with similar effect. In particular, a conductor can thus be easily (e.g., automatically) brought into contact with the surface roughness when the conductor is received into the slot 120. In some examples, the one or more surface roughness features can include a knurled profile 400, although other patterned profiles are possible. In either case, when using the split bolt connector 100, a user can thus remove an insulating coating from a conductor within the slot through the use of the one or more surface roughness features (e.g., a knurled or otherwise patterned raised profile). For example, in some installation methods, an insulating coating on the conductor can be abrasively removed simply by movement of the conductor within the slot 120, to provide improved electrical continuity between the conductor and the split bolt connector 100.

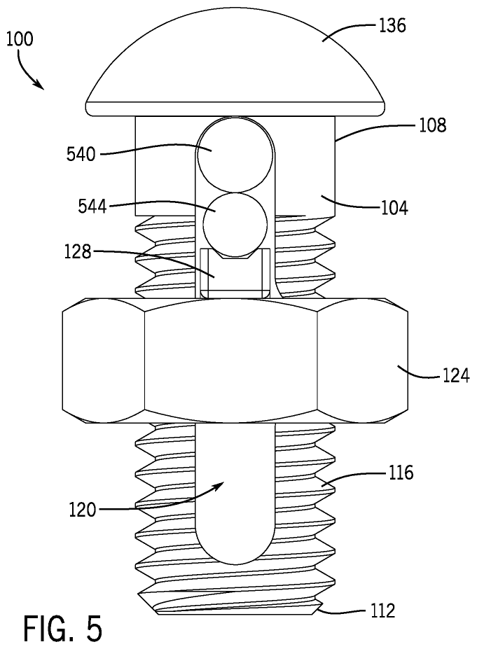

As shown in FIG. 5, the split bolt connector 100 (or other connectors disclosed herein) can be configured to connect a first conductor 540 (e.g., a wire, as shown) and a second conductor 544 (e.g., a wire, as shown), as well as for various other connections. For example, a user can install the split bolt connector 100 onto the first conductor 540 to secure the connector 100 to a structure and can then insert the second conductor 544 into the slot 120 of the split bolt connector 100 to be secured by the tightened nut 124 and the insert 128. Thus, when the split bolt connector 100 is in an installed configuration, the first and second conductors 540, 544 can be secured together in electric continuity and, as applicable, the second conductor 544 can be thus electrically and mechanically connected to a relevant support structure. Although not expressly illustrated for all example configurations, similar operations can also be implemented with either of the split bolt connectors 200, 300 presented above, or various other examples presented below.

In some examples, the first conductor 540 can be a conductor of a cable tray, such that the split bolt connector 100 as shown can provide electrical continuity between the second conductor 544 and the cable tray. In other examples, however, the first conductor 540 can be otherwise configured (e.g., as a fence wire). Further, as also generally noted above, a split bolt can be otherwise secured to relevant support structure in other examples (e.g., using the post 340 shown in FIG. 3).

Also as noted above, some examples can include bolt bodies that are formed with surface roughness to assist in creating appropriate conductive contact with the relevant cable tray or other component. In this regard, for example, machined or otherwise formed surface roughness on the split bolt connector 100 (e.g., similar to the knurled profile 400 of FIG. 4, or other patterned profile), can be used to remove an insulating coating from either of the conductors 540, 544 within the slot 120 or at other times during installation. In particular, as shown in FIG. 4, the profile 400 or other surface roughness can be included within the slot of a split bolt. Accordingly, for example, a surface coating on a cable tray can be removed after the relevant bolt receives the relevant tray wire. In other examples, however, other configurations are possible (e.g., with roughness outside of a relevant slot).

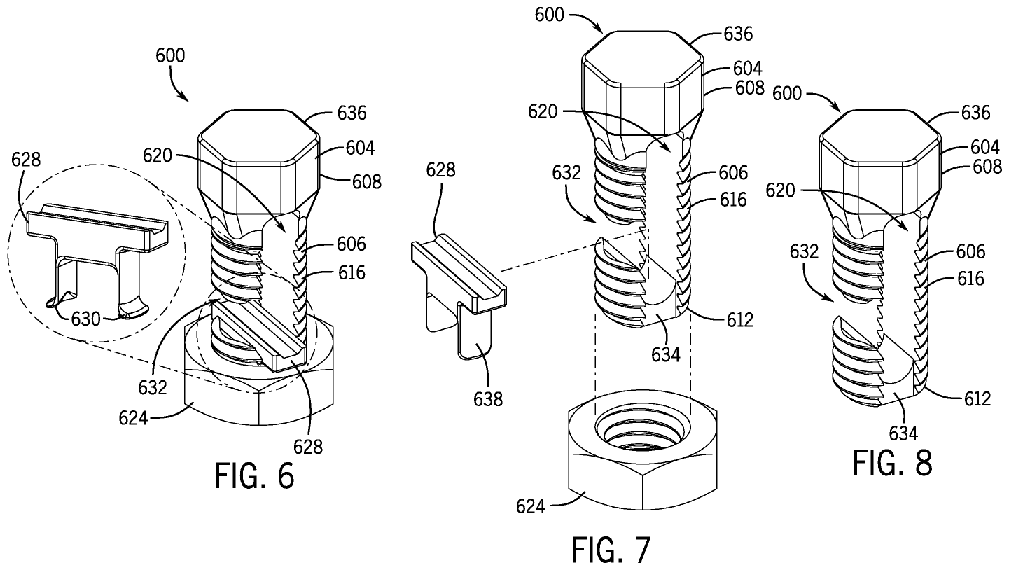

FIGS. 6 and 7 illustrate another example split bolt connector 600 that includes a main body 604 having a shaft 606 that includes external threads 616 and defines an axial direction between the first end 608 and second end 612 of the main body 604. Similarly to the split bolt connectors 100, 200, and 300, the split bolt connector 600 includes a slot 620 that extends between a first end 608 and a second end 612 of the main body 604 in the axial direction and a nut 624 engaged with the external threads 616 to be threadedly movable along the slot 620.

In the illustrated example, the split bolt connector 600 further includes an insert 628 within the slot 620. As shown, the insert 628 is configured to be movable along the slot 620 by rotation of the nut 624, as also generally discussed above. Further, the main body 604 defines a lay-in opening 632 along the slot 620 to receive a conductor laterally through the main body 604 and into the slot 620. Thus, for example, the conductor can be secured via movement of the insert 628 along the slot 620, without requiring removal of the nut 624 or the insert 628.

In some examples, the insert 628 further includes legs 638 that can be bent at free ends 630 (e.g., as shown in the inset view of FIG. 6). This bent structure can engage the free ends 630 with an axial face of the nut 624—e.g., facing opposing the first end 608 of the main body 604, as shown—to secure the insert 628 to the nut 624.

Correspondingly, as shown in FIG. 8 in particular, the second end 612 of the main body 604 includes a smoothed portion 634 extending in the axial direction (parallel to the slot 620) where the external threads 616 do not fully wrap around the entire circumference of the main body 604. Thus, a respective non-threaded groove extends axially along two opposing sides of the second end 612 of the main body 604, from the lay-in opening 632 toward the terminus of the second end 612 of the main body 604.

In use, during translation of the insert 628 along the slot 620, these opposing grooves on the main body 604 can receive and translationally guide the legs 638 (and the insert 628 in general) while aligning the legs sufficiently radially inward to avoid (excessive) interference with rotation of the nut 924. Correspondingly, the main body 604 can accommodate smooth movement of the insert 628 with the insert 628 (simply and easily) secured to the nut 624 via the outwardly bent ends 630 of the legs 638. Further, a relatively large range of movement can be provided for the insert 628 within the slot 620, because the nut 624 can be advanced beyond the lay-in opening 632, along the second end 612 of the main body 604, without the material of the main body 604 impeding translational movement of the insert 628 (and the legs 638 in particular). As shown in FIG. 11, the smoothed portion 634 can extend along the full length of the main body 604 between the lay-in opening 632 and the terminus of the main body 604 at second end 612, to provide for casy assembly and maximum adjustability. In other examples, however, other configurations are possible.

In the illustrated example, the main body 604 includes a head 636 at the first end 68 that defines a flattened axial profile, with a larger diameter than the body 604 measured perpendicular to the axial direction. In particular, the head 636 is a polygonal head with a hexagonal (as shown) perimeter that defines the larger diameter of the head 636. In other examples, however, other head profiles are possible (e.g., with rounded profiles, threaded posts, set screws, etc.). For example, the head 636 can be a circular round head as illustrated for the head 136 of FIG. 1 or can include a post 340 as shown for the head 336 of FIG. 3.

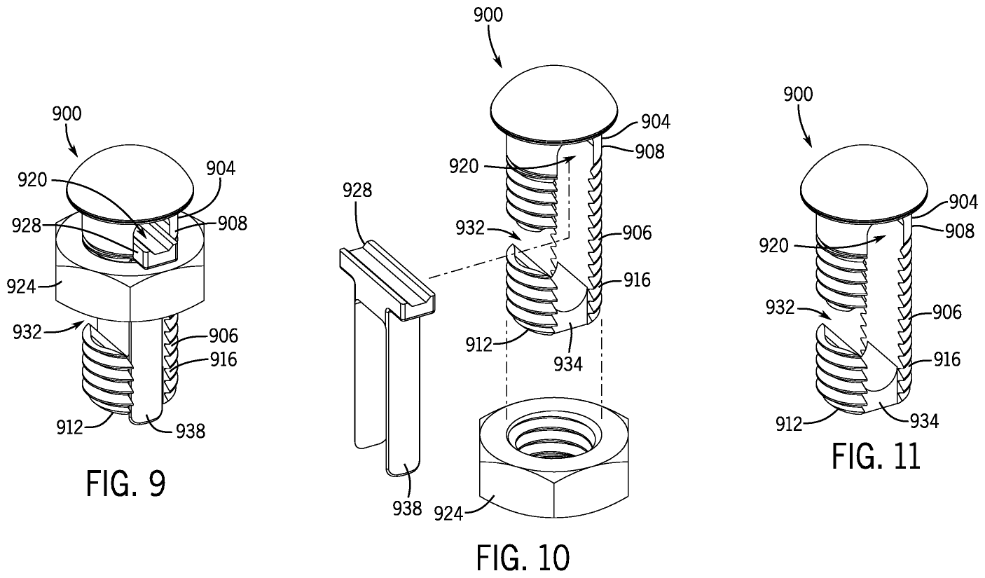

FIGS. 9 and 10 illustrate another example split bolt connector 900 that includes a main body 904 having a shaft 906 that includes external threads 916 and defines an axial direction between a first end 908 and a second end 912 of the main body 904. Similarly to the split bolt connectors 100, 200, 300, and 600, the split bolt connector 900 includes a slot 920 that extends between the first end 908 and the second end 912 of the main body 904 in the axial direction and a nut 924 engaged with the external threads 916 to be threadedly movable along the slot 920. As shown in FIG. 11 in particular, parallel to the slot 920 at the second end 912 of the main body 904 the body 904 includes a smoothed portion 934 where the external threads 916 do not fully wrap around the entire body 904 of the split bolt connector 900. Correspondingly, a non-threaded groove extends axially along opposing sides of the main body 904, between the first and second ends 908, 912 thereof.

In the illustrated example, the split bolt connector 900 further includes an insert 928 within the slot 920. As shown, the insert 928 is configured to be movable along the slot 920 by rotation of the nut 924, as also generally discussed above. Further the main body 904 defines a lay-in opening 932 along the slot 920 to receive a conductor laterally through the main body 904 and into the slot 920. Thus, for example, the conductor can be secured via movement of the insert 928 along the slot 920 without requiring removal of the nut 924 or the insert 928.

In the example shown, the insert 928 further includes legs 938 that extend axially through (and beyond) the nut 924, and to various axial distances beyond the nut 924 during installation and service (e.g., to various distances axially beyond the lay-in opening 932 or the terminus of second end 912 of the main body 904). Correspondingly, the insert 928 may be securely retained as part of the assembled split bolt connector 900, in various assembled configurations, without the legs 938 needing to be bent during manufacturing to engage the nut (e.g., in contrast to the legs 638 as discussed above). In other examples, however, as also noted below, the legs 938 can be formed with a shorter length and secured with bent ends, similarly to the legs 638.

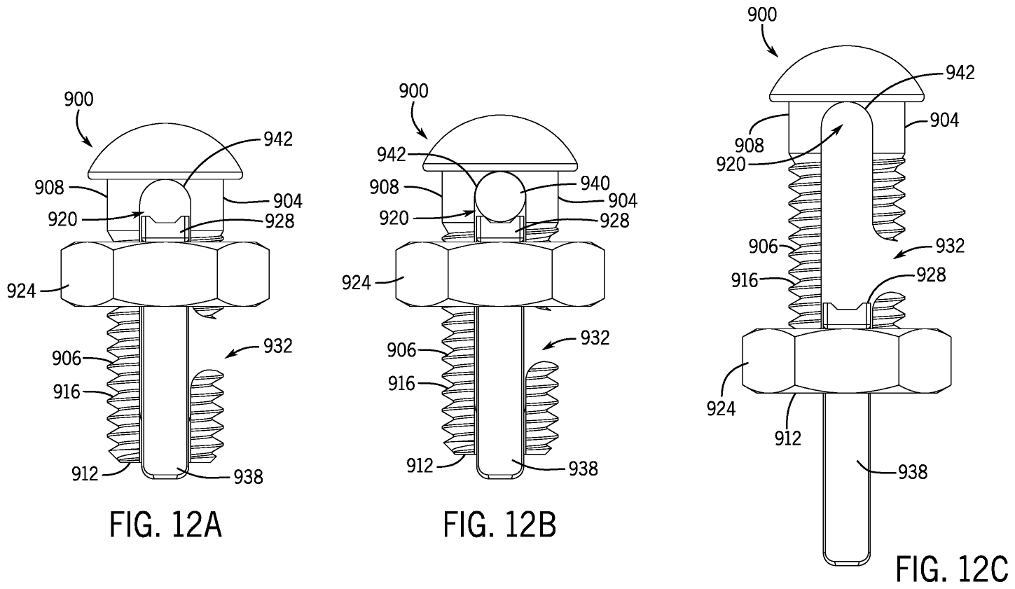

As shown in FIG. 12A, the nut 924 is advanced as far as possible along the main body 904 (e.g., so that insert 928 is also advanced as far into the slot 920 as possible). Correspondingly, the nut 924 is between the lay-in opening 932 and the first end 908 of the main body 904. With the split bolt connector 900 thus arranged, the legs 938 extend axially at least beyond the lay-in opening 932 or farther (i.e., by various distances along or beyond the second end 912 of the main body 904, as shown). Thus, in a fully tightened configuration, the insert 928 can be securely retained within the slot 920 and the connector 900 overall may present a relatively compact, unitary package (e.g., for easy transport, staging, etc.).

Continuing, as shown in FIG. 12B, the nut 924 is still positioned fully beyond the lay-in opening 932, in the direction of the first end 908 (i.e., the nut 924 is still aligned between the lay-in opening 932 and the first end 908, with full engagement between the internal threads of the nut 924 and the threads 916). As shown, this arrangement may dispose the insert 928 to secure a conductor 940 within the slot 920. In particular, in the example illustrated, the insert 928 is advanced into the slot 920 toward the first end 908 of the main body 904 so that contact surface 942 on the insert 928 secures the conductor 940against the blind end of the slot 920. In such a configuration, again, the legs 938 can extend at least beyond the lay-in opening 932 and. potentially, beyond the second end 912 of the main body 904 (as shown).

In the example shown, the conductor 940 is a round wire and has a diameter that is equal to the diameter formed by the radiused blind end of the slot 920 (and the associated width of the slot 920). Correspondingly, the conductor 940 can seat flush against the blind end of the slot 920, with the contact surface 942 spaced away from by the blind end by the diameter of the conductor 940 (and the diameter of the blind end itself). In other examples, other spacings are possible, as well as other geometries for conductors (e.g., oblong wires of various widths) and for the blind ends of connector slots (e.g., with angled or flattened blind ends), and discussion herein relative to round wires or radiused slots also generally applies to differently shaped conductors and slots.

As shown in FIG. 12C, the nut 924 is positioned so that nut 924 and insert 928 are clear of the lay-in opening 932. Correspondingly, the conductor 940 (not shown in FIG. 12C) can be inserted through the lay-in opening 932 into the slot 920. In particular, the nut 924 is illustrated in a position that is advanced as far along the second end 912 of the main body 904 as possible while retaining full engagement between the threads of the nut 924 and the external threads 916. In other examples, the nut 924 may be differently positioned between the lay-in opening 932 and the terminus of the second end 912 of the main body 904 (i.e., at other locations along the second end 912), while still locating the insert 928 so as to allow passage of a conductor through the lay-in opening 932.

With the nut 924 and the insert 928 clear of the lay-in opening 932 (e.g., as shown in FIG. 12C), the legs 938 of insert 928 extend axially through nut 924 and beyond the end 912 of the main body 904 to help retain the insert 928 within the slot 920. Further, even with the insert 928 displaced from the position shown (e.g., to the position shown in FIG. 12A) or the nut 924 advanced even further away from the lay-in opening 932 (e.g., to be engaged minimally with the external threads 916), the legs 938 may still remain engaged within the nut 924 to help retain the insert 928 within the slot 920.

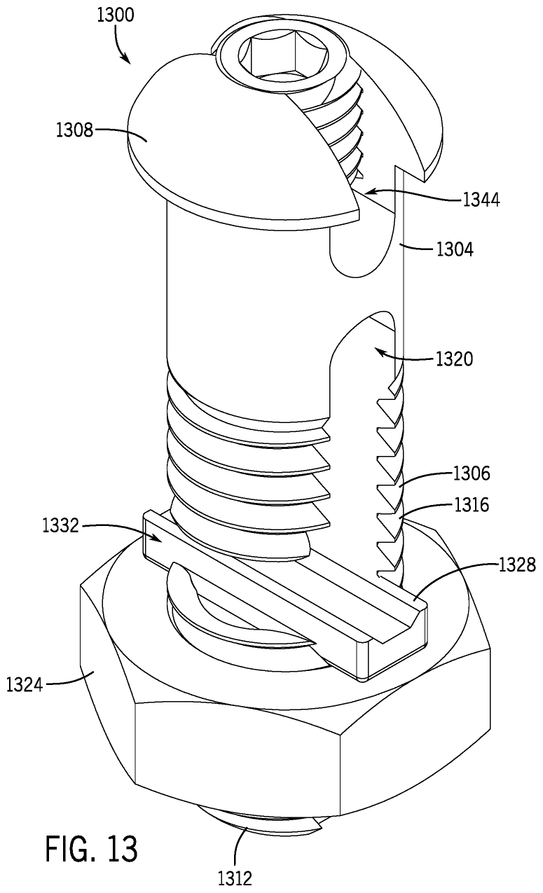

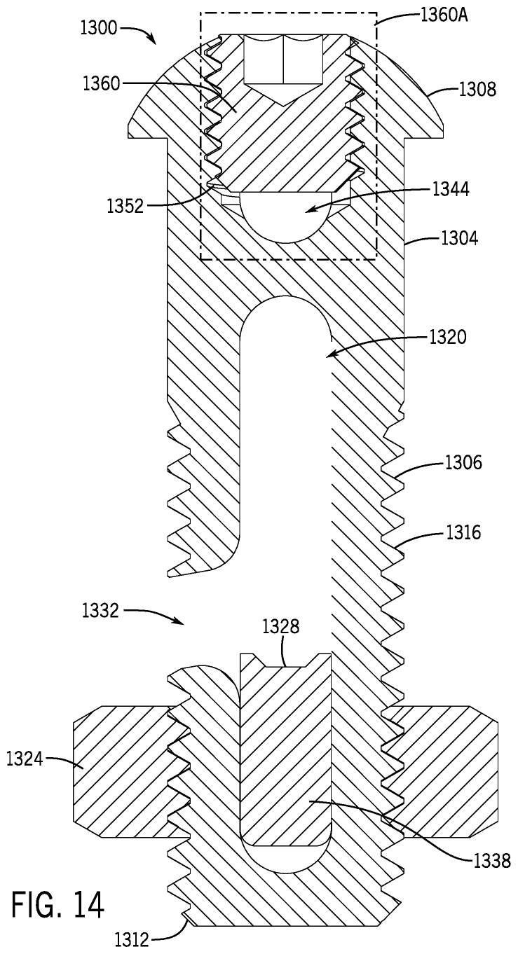

FIGS. 13 and 14 illustrate another example split bolt connector 1300 that includes a main body 1304 having a shaft 1306 that includes external threads 1316 and defines an axial direction between the first end 1308 and second end 1312 of the main body 1304. The split bolt connector 1300 includes a first slot 1320 that extends between the first end 1308 and the second end 1312 of the main body 1304 in the axial direction. The main body 1304 further defines a lay-in opening 1332 along the first slot 1320 to receive a conductor laterally through the main body 1304 and into the slot 1320 (e.g., as further discussed below). A nut 1324 can be engaged with the external threads 1316 to be threadedly movable along the first slot 1320.

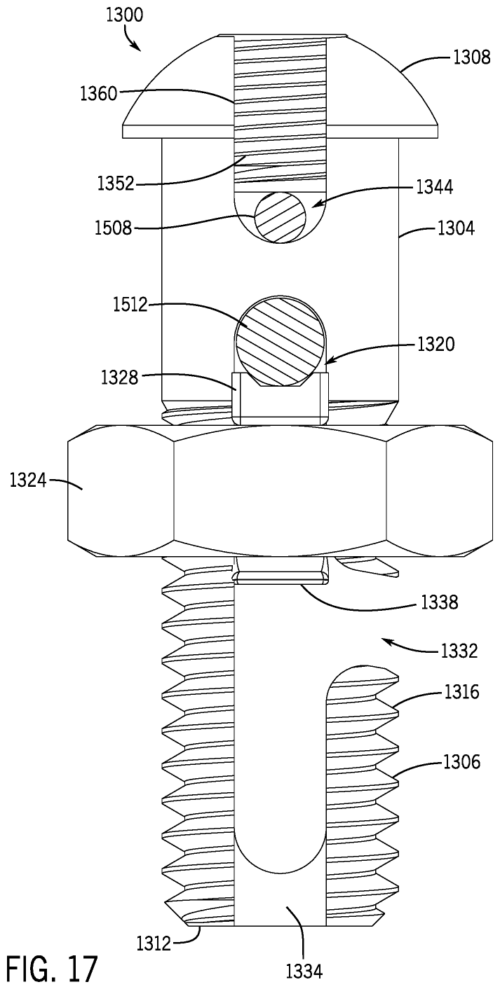

The split bolt connector 1300 can further include an insert 1328 within the first slot 1320, movable along the first slot 1320 by rotation of the nut 1324. Parallel to the first slot 1320 at the second end 1312 of the main body 1304, the main body 1304 includes a smoothed portion 1334 (see FIG. 17) where the external threads 1316 do not fully wrap around the entire main body 1304 of the split bolt connector 1300. As similarly discussed above, legs 1338 of the insert 1328 can be secured to the nut 1324 at bent ends of the legs 1338, and can move along the smoothed portion 1334 of the main body 1304 depending on the position of the nut 1324.

The split bolt connector 1300 further includes a second slot 1344 that extends along the first end 1308, but remains separated from the first slot 1320 by material of the main body 1304. In the illustrated example, the second slot 1344 further includes an internal threaded section 1352. Accordingly, a set screw 1360 can be engaged with the threads of the internal threaded section 1352 to be threadedly movable along the second slot 1344.

In some examples, a skirt or other structure can be provided around the set screw 1360, the slot 1344, or otherwise, to help prevent the assembled split bolt connector 1300 (e.g., including a conductor secured by the set screw 1360) from snagging on other components. In some examples, other structures can be provided in place of the threaded section 1352 and the set screw 1360, to secure a conductor within the second slot 1344. As schematically illustrated in FIG. 14, for example, a retention mechanism 1360A may include a tapered or other pin and corresponding receiving structures, various press-fit or snap-fit structures, a crimp-able section of the main body 1304, or various other known structures for securing a conductor to another body.

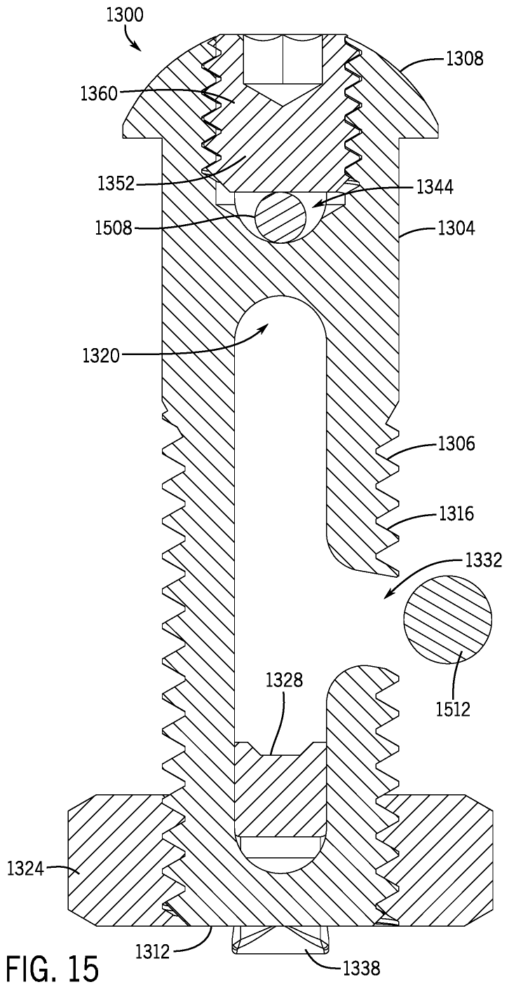

In the illustrated configuration, the legs 1338 of the insert 1328 of the split bolt connector 1300 are relatively short. Accordingly, as also noted above, the legs 1338 can be secured to the nut 1324 as similarly discussed relative to the legs 638 (e.g., as illustrated in FIG. 15). In other configurations, the legs 1338 can instead be configured similarly to the legs 938 (e.g., as illustrated in FIGS. 12A through 12C). Correspondingly, discussion of the of the legs 938 can also apply to the legs 1338 in some configurations of the split bolt connector 1300.

Further, although a second slot is illustrated in particular for the split bolt connector 1300, other examples discussed above may also be similarly configured, with second slots extending into the relevant main body. Correspondingly, discussion above and below relative to the second slot 1344 in particular can also apply to second slots in example configurations of the various split bolt connectors 100, 200, 300, 600, 900.

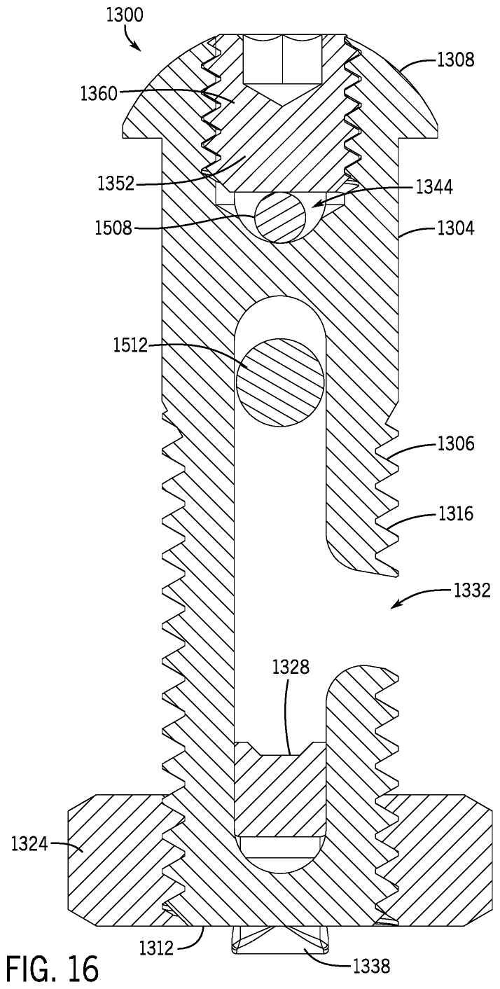

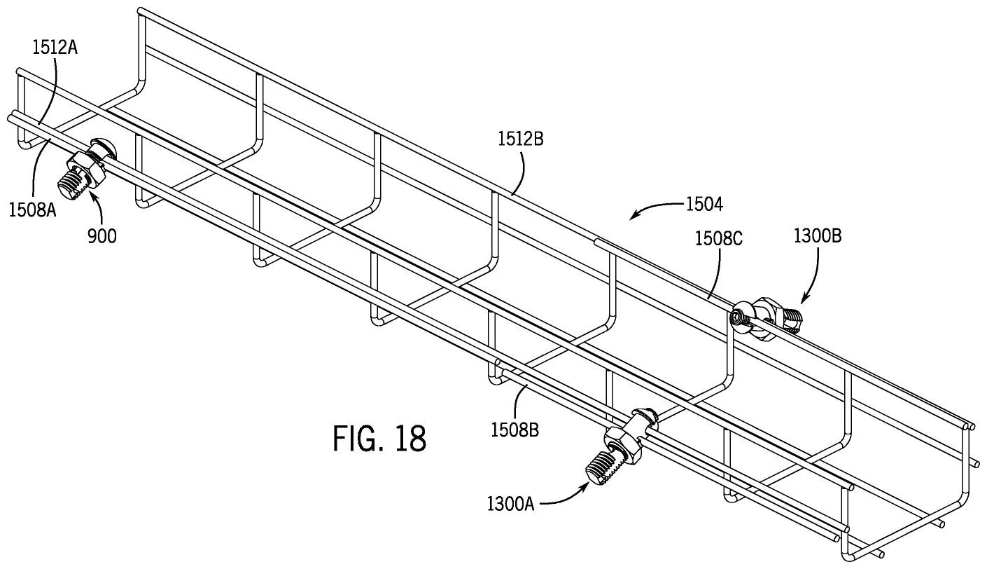

FIGS. 15 through 17 illustrate an example method of installing the split bolt connector 1300 to provide electrical connections between a cable tray 1504 (see FIG. 18) and a separate conductor 1508 (e.g., a wire for electrical bonding of the tray 1504, as further discussed below). Although this application may represent a particularly useful implementation of the disclosed split bolt connector, similar operations can also be implemented to secure other types of components together (e.g., to electrically bond together various other conductors).

As shown in FIG. 15 in particular, a user can align the split bolt connector 1300 with the cable tray 1504 so that the lay-in opening 1332 is aligned with a wire 1512 (or other structure) of the cable tray 1504. In particular, the nut 1324 can be already engaged with the external threads 1316 of the shaft 1306 to secure the insert 1328 within the first slot 1320, so that the user may need to manage only a single component. The user can then move the main body 1304 to insert the wire 1512 of the cable tray 1504 laterally into the first slot 1320 via the lay-in opening 1332. With the wire 1512 thus received, the user can tighten the nut 1324 to move the insert 1328 axially along the slot 1320 and thereby secure the wire 1512 within the first slot 1320.

In some examples, prior to securing the wire 1512, a coating can be removed from the wire 1512 using the split bolt connector 1300. For example, surface roughness features within the first slot 1320 (as discussed generally above) can be used to scrape away an insulating coating on the wire 1512 so that an appropriate electrical connection can be made between the main body 1304 and the wire 1512.

Continuing, the conductor 1508 can also be secured to the main body 1304 to electrically connect the conductor 1508 to the wire 1512 of the cable tray 1504. Thus, for example, the split bolt connector 1300, with the conductor 1508 attached, can be easily installed to provide electrical bonding (or other connections) between the cable tray 1504 and other components (not shown).

In some examples, the conductor 1508 can be pre-attached to the main body 1304 so that an installer may need to manage only a single unified assembly, with no loose parts, to provide a bonding (or other) connection with a cable tray (or other component). For example, a pre-fabricated assembly of a split bolt (e.g., the split bolt connector 1300, as shown) and a conductor (e.g., the conductor 1508, as shown) can be prepared at a first location, then transported (e.g., shipped) to a second location for installation.

Alternatively, a pre-fabricated assembly of a split bolt connector (e.g., the split bolt connector 1300, as shown) and the cable tray 1504 can be prepared at first location, then transported (e.g., shipped) to a second location for installation and then attachment to the conductor 1508. In such an approach, for example, the wire 1512 may be secured in the second slot 1344 with the set screw 1360, and the conductor 1508 may be later secured within the first slot 1320.

In the illustrated example, the conductor 1508 is secured with the set screw 1360. As also noted above, other configurations are possible in other examples. For example, as schematically indicated by retention mechanism 1360A in FIG. 14, a variety of structures can be provided, including a tapered or other pin, a crimp-able section of the main body 1304, or various other known structures for securing a conductor to another body.

FIG. 18 illustrates an example assembly of the split bolts of FIG. 9 and of FIG. 13 used to attach a cable tray 1504 and various bonding wires. In one example, the split bolt connector 900 (see also, e.g., FIG. 12B) receives a wire 1512A of the cable tray 1504 and a bonding wire 1508A in the slot 920. The wire 1512A and the bonding wire 1508A are thus in direct contact with each other as the nut 924 is tightened to secure the wires 1512A, 1508A collectively within the split bolt 900. In the illustrated example, the insert 928 of the split bolt connector 900 is configured with a shorter length for the legs 938 (e.g., as also shown for the connector 1300), although other examples can include a longer length for the legs 938 (e.g., as discussed above, and shown in FIGS. 12A through 12C).

In another example, a split bolt connector 1300A can be an example of the split bolt connector 1300 (see also, e.g., FIG. 17). In some cases, the split bolt connector 1300A can receive the wire 1512A in the second slot 1344 and receive a bonding wire 1508B in the first slot 1320. For example, a pre-fabricated assembly of the tray 1504 and the split bolt connector 1300A can be prepared and installed, and then a user can later easily secure the bonding wire 1508B within the first slot 1320 without removing or loosening the spit bolt connector 1300A relative to the tray (or, e.g., only loosening the split bolt connector 1300A for slight angular adjustments).

In yet another example, a split bolt connector 1300B can be another example of the split bolt connector 1300 (see also, e.g., FIG. 17). In some cases, the split bolt connector 1300B can receive a wire 1512B in the first slot 1320 and a bonding wire 1508C in the second slot 1344. For example, a pre-fabricated assembly of the split bolt connector 1300A and the bonding wire 1508B can be carried by an installer to the location of the cable tray 1504 and then easily secured to the wire 1512A (or another wire) without removing any components of (or from) the cable tray 1504 and without having to manage loose nuts or other unsecured parts.

In the examples presented above, a variety of configurations are presented for heads, inserts, and other components of split bolt assemblies. As also generally noted above, unless required by structural differences or otherwise specified, discussion of particular functionality for any given example is also applicable to other examples, and one or more components of any one configuration as illustrated or discussed above may be substituted or otherwise added into any of the others. In this regard, for example, although a round head is presented relative to the examples of FIGS. 1, 4, 5, 9-11, and 13-15, other configurations of the illustrated example may include a hexagonal head as shown in FIGS. 2, 3, and 6-8, a threaded post as shown in FIG. 3—and similar interchanges of structures are also possible relative to the examples of FIGS. 2, 3, and 6-8 (e.g., to include a rounded head or a threaded post) and the examples of FIG. 3 (e.g., to include a rounded head or exclude a threaded post).

Similarly, although inserts with extended legs are specifically presented relative to FIGS. 6-14, with corresponding configurations of the threaded body, similar inserts and threaded bodies can be implemented for any of the illustrated configurations, including with substitution of insets having legs of different lengths (e.g., as separately shown in FIGS. 7 and 10).

Still further, although set screws and other retention mechanisms are discussed and shown particularly regarding the examples of FIGS. 13 through 18, similar structures can be included for other implementations (e.g., relative to the examples illustrated in any of FIGS. 1 through 12C).

In various examples above, split bolt connectors are presented as useful connectors for grounding and bonding applications. Correspondingly, some examples of the split bolt connectors disclosed herein can be formed with various materials known in the art to be suitable for these applications. In some examples, split bolt connectors can be tinned, which may be useful in particular for non-grounding applications.

Thus, embodiments of the invention can provide an improved split bolt connector. In some embodiments, for example, a split bolt connector can include a main body defining a lay-in opening along a slot of the main body, which may enable a quicker and easier installation process as compared to conventional designs. As another example, some embodiments can include one or more surface roughness features within or near a slot of a main body of a split bolt connector to efficiently remove an insulating coating from a conductor within the slot to quickly secure grounding during the installation process.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features for a particular embodiment, regardless of the absolute orientation of the embodiment (or relative orientation relative to environmental structures). “Lateral” and derivatives thereof generally indicate directions that include non-zero components that are perpendicular to an axial direction for a relevant reference frame (e.g., extending in a radial direction relative to a reference axis or axial direction).

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of +20% or less (e.g., +15, +10%, +5%, etc.), inclusive of the endpoints of the range. Similarly, as used herein with respect to a reference value, the term “substantially equal” (and the like) refers to variations from the reference value of less than +5% (e.g., +2%, +1%, +0.5%) inclusive.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A method of connecting a conductor and a cable tray, the method comprising:
aligning a main body of a split bolt connector with a cable tray so that a lay-in opening is aligned with a wire of the cable tray, with a nut engaged with external threads of a shaft to secure an insert within a first slot that extends in an axial direction between first and second ends of the main body;
moving the main body to insert the wire of the cable tray laterally into the first slot via the lay-in opening;
tightening the nut to move the insert axially along the first slot to secure the wire within the first slot; and
securing a conductor to the main body to electrically connect the conductor to the wire of the cable tray.

2. The method of claim 1, further comprising:
before tightening the nut to secure the wire with the insert within the first slot, removing an insulating coating from the wire, using one or more surface roughness features on the main body of the split bolt connector.

3. The method of claim 2, wherein the one or more surface roughness features are located within the first slot and the insulating coating is removed after the wire is inserted into the first slot.

4. The method of claim 1, wherein the main body includes a second slot, separated from the first slot by material of the main body; and
wherein securing the conductor to the main body includes securing the conductor within the second slot.

5. The method of claim 4, wherein the main body receives a set screw aligned with the second slot; and
wherein securing the conductor to the main body includes securing the conductor within the second slot with the set screw.

6. The method of claim 1, wherein the conductor is secured to the main body before the main body is secured to the cable tray.

7. The method of claim 1, further comprising:
attaching the main body to the conductor with a threaded post that extends from a head of the main body.

8. The method of claim 1, wherein securing the conductor to the main body electrically bonds the cable tray to a tray assembly that includes a plurality of cable trays.

9. The method of claim 1, wherein, with the nut tightened to secure the wire within the first slot at the first end of the main body, legs of the insert extend axially through the nut and beyond the lay-in opening away from the first end of the main body.

10. The method of claim 9, wherein one or more of:
with the nut tightened to secure the wire within the first slot at the first end of the main body, the legs of the insert extend axially through the nut and beyond the second end of the main body; or
with the nut and the insert aligned along the main body to receive the wire into the lay-in opening, the legs of the insert extend axially through the nut and beyond the second end of the main body.

11. A split bolt connector assembly comprising:
a split bolt connector that includes:
a main body having a shaft that includes external threads and defines an axial direction, and a first slot that extends between first and second ends of the main body in the axial direction;
a nut engaged with the external threads to be threadedly movable along the external threads; and
an insert within the first slot, the insert being movable in the axial direction along the first slot by rotation of the nut;
the main body defining a lay-in opening along the first slot that opens laterally through the main body into the first slot; and
one or more of:
the main body including a second slot that is separated from the first slot by material of the main body and opens out of the main body at the first end of the main body; or
the split bolt connector having an installed configuration in which the insert is seated on the nut with the nut at least partly between the lay-in opening and the first end of the main body and legs of the insert extend axially through the nut and beyond the lay-in opening.

12. The split bolt connector assembly of claim 11, wherein legs of the insert extending axially through the nut and are bent outwardly at free ends to secure the insert to the nut;
wherein the main body includes grooves that extends axially along opposing sides of the second end of the main body to receive the legs of the insert when the nut is aligned along the second end of the main body.

13. The split bolt connector assembly of claim 11, wherein the main body includes, within or adjacent to the first slot, one or more surface roughness features arranged to score a conductor received into the first slot.

14. The split bolt connector assembly of claim 11, wherein the main body includes the second slot; and
wherein the main body receives a set screw that is aligned with the second slot to be advanced into the second slot to secure a conductor within the second slot.

15. The split bolt connector assembly of claim 11, wherein the split bolt connector assembly is a prefabricated assembly that includes a first conductor secured within the second slot.

16. The split bolt connector assembly of claim 15, wherein one of:
the first conductor includes a wire of a cable tray; or
the prefabricated assembly is secured to a wire of a cable tray with the wire secured in the first slot by the insert to be electrically connected to the first conductor.

17. The split bolt connector assembly of claim 11, wherein, with the split bolt connector in the installed configuration, the legs extend axially through the nut and beyond the second end of the main body.

18. The split bolt connector assembly of claim 11, wherein a first end of the insert includes a contact surface that is oriented to contact a wire that is received within the first slot to secure the wire against a blind end of the first slot at the first end of the main body;
wherein the blind end of the first slot defines a first width, perpendicular to the axial direction, the first width corresponding to a first wire diameter; and
wherein, with the contact surface of the insert spaced axially from the blind end within the first slot by a distance equal to the first width, the legs of the insert extend axially through the nut and beyond the second end of the main body.

19. The split bolt connector assembly of claim 11, wherein the main body includes a head at the first end that defines one or more of:
a rounded axial profile, with a larger diameter than the main body measured perpendicular to the axial direction;
a flattened axial profile, with a larger diameter than the main body measured perpendicular to the axial direction; or
a threaded post extending from the head in the axial direction.

20. A method of prefabricating a connector assembly, the method comprising:
securing a nut to external threads of a shaft of a main body of a split bolt connector, to secure an insert within a first slot that extends in an axial direction along the shaft between first and second ends of the main body, with a lay-in opening provided into the first slot to receive a wire of a cable tray into the first slot to be secured by the insert to electrically bond the main body to the wire; and
securing a conductor within a second slot of the main body that is separated from the first slot by material of the main body so that the conductor is electrically bonded to the main body.
